(19) United States
(12) Patent Application Publication
(10) Pub. No.: US 2010/0241689 A1
(43) Pub. Date: Sep. 23, 2010

(54) METHOD AND APPARATUS FOR ASSOCIATING ADVERTISING WITH COMPUTER ENABLED MAPS

(75) Inventors: Marc E. Davis, San Francisco, CA (US); Christopher W. Higgins, Portland, OR (US); Christopher T. Paretti, San Francisco, CA (US); Athellina Athsani, San Jose, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: YAHOO! INC., Sunnyvale, CA (US)

(21) Appl. No.: 12/407,690

(22) Filed: Mar. 19, 2009

(51) Int. Cl. G06F 3/048; G06F 15/16

(52) U.S. Cl. 709/203; 715/764

(57) ABSTRACT

An interactive system and method based on the Internet and intended for advertising distribution uses collectively authored (user generated) content and maps that are interactive. The maps are personalized with the user generated content and with targeted advertising units and transmitted to a user. This provides an interactive user experience in terms of both the advertising and content generated by other users relating to an advertiser offer, but having the personalized aspect, making it more effective as advertising.

### FIELD OF THE INVENTION

This disclosure relates to the Internet and Internet communications and specifically Internet distributed maps which are interactive.

### BACKGROUND

U.S. patent publication US 2008/0148175A1, published Jun. 19, 2008, first named inventor NAAMAN, incorporated herein by reference in its entirety, discloses the “tag maps” technology. Briefly, this visualizes datasets by associating text (keywords) with geolocations on a displayed computer map and optionally with or over time. The visualization is intended to help the computer user better understand and analyze the contents of the dataset as associated to one or more geolocations. The visualization takes as input a keyword and related parameters such as location, importance/relevance factors, time, visualization level, and keyword category and displays on the user's computer screen the selected keywords on a map with their associated location with the size or other characteristic of the keyword shown according to its relevance to some metric such as popularity. This is in the context of the Internet where the map database is maintained at a server and a user accesses this via the Internet via a client (software) such as a web browser at his computer remotely. In this case, FIG. 1 shows an outline map of the city of San Francisco, Calif. and part of San Francisco Bay with superimposed on the map a dataset of SMS text messages originating or associated with the San Francisco location and showing three movie titles, sized according to their popularity. Note that these text messages are not intrinsically linked to a particular geographic location or feature on the map, but merely happen to be movies being presented somewhere in San Francisco. In this case, the details of the map have been suppressed in terms of actual geographical details, but these may be displayed also.

FIG. 2, taken from the same patent application document, shows a system for providing the tag maps. “Tag” is a reference to the text shown in FIG. 1, also known as keywords or a dataset or text string. User or client 1 at a personal computer 2 executing a conventional web browser 4 and optionally a client-side visualization application (not required) may access a website over the Internet or other network 6 being hosted on a main server 8. Main server 8 may be executing a visualization algorithm 20 to perform visualization at the website. Alternatively, the main server 8 may be in communication with a second server 10 over a private network or the Internet wherein the visualization algorithm 20 is performed at the second server and the results are sent back to the main server 8.

A storage device or memory 12 may store one or more datasets such as a dataset of photos, SMS messages such as in FIG. 1, search terms and the like. A context server 14 may operate on one or more datasets 22 to generate visualization data 16 comprised of keywords or labels and other values associated with each label such as latitude, longitude, a time or time range for which the information is valid, and one or more associated relevance values. Note that servers 8 and 14 may be combined into one server. Separate servers are a combination of a number of servers. The user may use a client-side application to request that certain visualization data be visualized using a particular visualization scheme and they also request a particular map area. Main server 8 or second server 10 then performs a visualization algorithm on the visualization data 16 and maps data from the map server 18. The map server 18 produces conventional interactive computer-type map information in accordance with the geographical request from the user 1. While the map server shown in FIG. 2 is a separate server, it may be the same server as the main server 8 or the second server 10 or the context server 14. The main server 8 or second server 10 then produces rendering information and transmits it to the personal computer 2 so that it can be rendered by the web browser 4 or used by the user.

### SUMMARY

This disclosure is directed to improvements over the above described tag maps by including advertisements therein. These advertisements are not simple text strings as shown in FIG. 1, but include advertising content which may be interactive and is typically more than mere text strings or images. Typically the ads are interactive, and include images or video or audio. The present system and method allow Internet advertising in combination with collectively authored content (such as user generated content) and commercially available maps to personalize targeting of an advertisement to a particular user and to provide an interactive user experience related to the advertiser or advertisement or offer, but which is generated from a repurposing of the user's attention. The advertising content is such that it is meant to increase user attention and advertising effectiveness for both brand and direct marketing advertising.

This is intended to improve upon typical Internet advertising which is not personalized, because it is sent to all users, and hence is little of interest to most recipients, and where conventional geo-located advertising typically provides too much information about locations and vendors in a small space. It has been found that consumers who view advertising increasingly expect user generated content (UGC as known in the computer field) associated with a particular map location when they are searching for stores, restaurants, products, entertainment, etc. It has been found that provision of user generated content, instead of merely the commercial content provided by the advertiser, shortens the sale cycle for specific products or services. User generated content in the computer field refers to content not generated by the advertiser or the website operator, but instead by other users. Hence it typically has a higher level of creditability than advertising or commercially oriented content.

### BRIEF DESCRIPTION OF THE DRAWINGS

FIG. 1 shows in the prior art a map with keyword text displayed thereon.

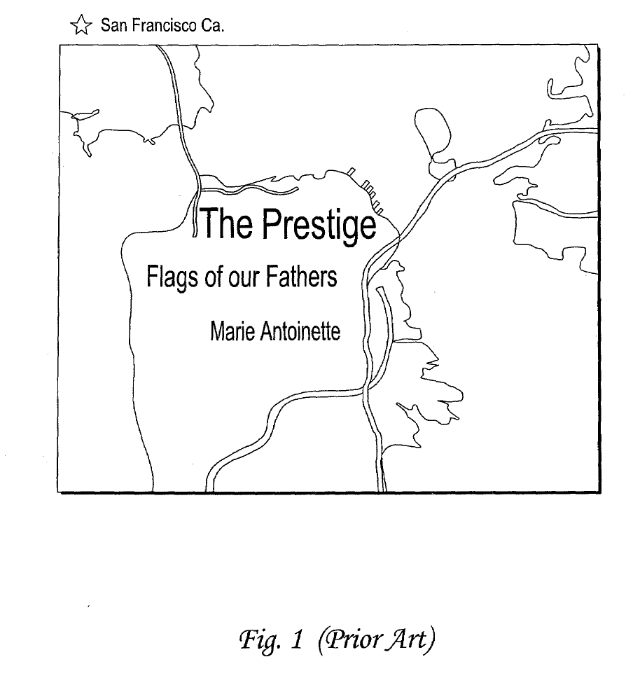

FIG. 2 shows in the prior art a system for accomplishing the map displayed in FIG. 1.

FIG. 3 shows a flow chart of activity in accordance with the present invention.

FIG. 4 shows a system for carrying out the process of FIG. 3.

FIGS. 5 and 6 show respectively screenshots of tag maps with advertising in accordance with the present invention.

FIG. 7 shows a computer system in the prior art also used in the context of the present system.

### DETAILED DESCRIPTION

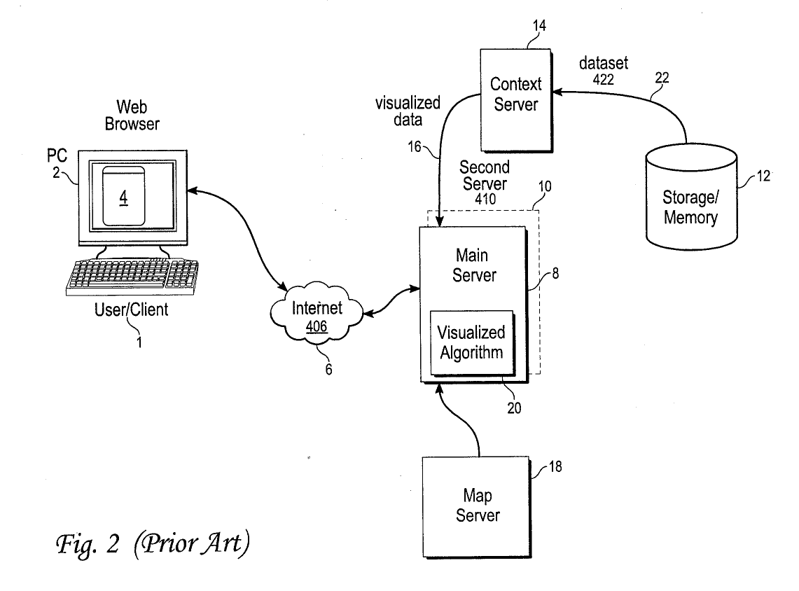

The present disclosure is directed to a system and associated method of augmenting conventional advertising copy as delivered over the Internet with a targeted interactive layer of geo (location)-related user generated content such as a tag map. (See also U.S. patent application Ser. No. ______, filed ______, attorney docket No. 32421-2025800, commonly assigned, inventors Athellina ATHSANI, Marc E. DAVIS, Christopher W. HIGGINS, Christopher T. PARETTI and directed to related subject matter.) The advertisements here are augmented with instances of related user generated content within the advertising copy to increase user reaction, interaction and thus make the ads more valuable and hence generate more revenue from the advertisers for the Internet system website operator. Typically such a system is associated with a website such as that of Yahoo! and advertisers purchase advertising through Yahoo! which would operate such a system. The advertisements themselves are manually or automatically generated in response to a request for a map display. The typical client device is shown in FIG. 2 as a personal computer 2, but instead may be a computer of other types, a web enabled mobile phone or other mobile computing device capable of Internet access or any device capable of supporting a user interactive medium used for content distribution in the computer context.

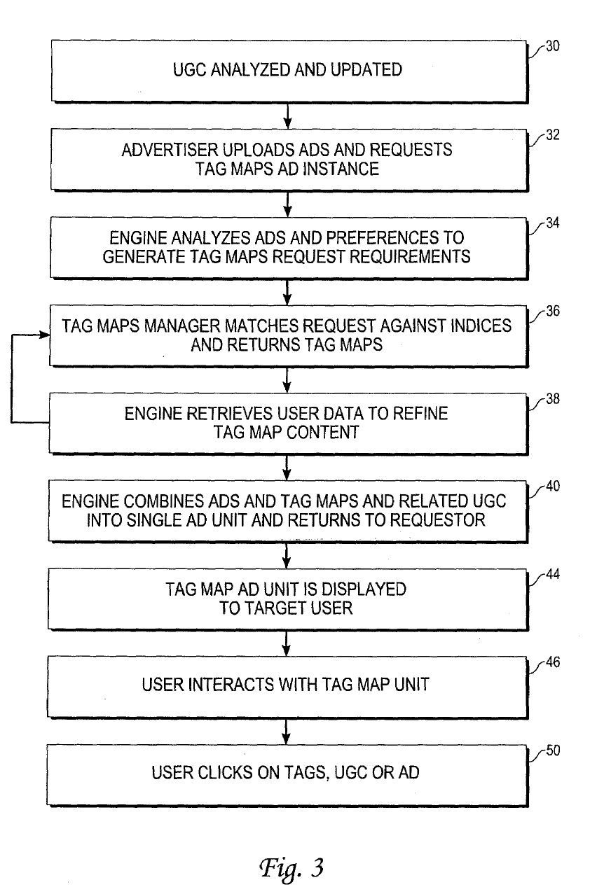

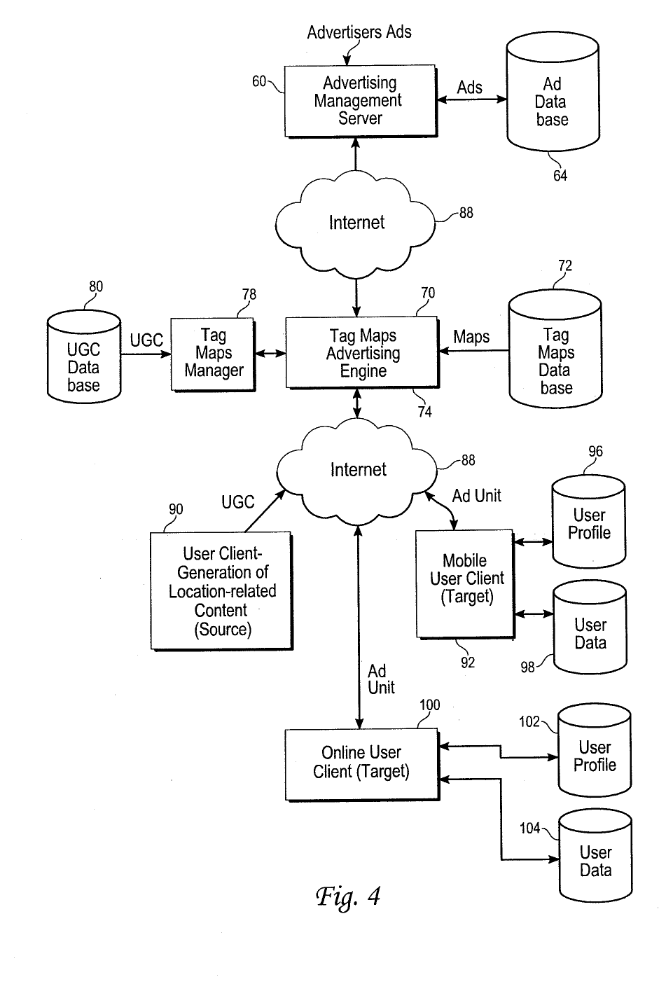

FIG. 3 shows in a flow chart operation of such a system and method. This typically operates in the context of a system similar to that of FIG. 2, but with added structure as also described further below with reference to FIG. 4. This system is typically accomplished by computer software executed on a computer server or servers as shown in FIG. 2 and explained further with regard to FIG. 4. This computer software is typically coded in any convenient computer language such as C++, Java or PHP (a scripting language for web pages) and stored on a computer readable medium such as a disk drive, tape drive or semiconductor memory associated with the server processor. In this context “server” generally refers to software which runs on a “server platform” which is a type of computer but “server” may also refer to a server platform with the server software.

In FIG. 3 in the first step 30, user generated content, which is generated by a user other than the one who is meant to view same, is analyzed and regularly updated to particular indices. Indices here are similar to a search corpus. In this case the UGC is indexed into appropriate categories, e.g. movies: Flags of Our Fathers, Marie Antoinette; travel: Golden Gate Bridge, Alcatraz. In the next step 32, an advertiser uploads his advertisements (or portions or elements thereof), referred to as advertising copy, and requests a tag maps ad unit instance with certain preferences. A tag maps ad unit instance is a combination of the map, the tags associated with the map, the relevant advertising copy, and some user generated content.

Next in step 34, an “engine” (logic embodied in server software) analyzes the advertising copy and preferences assigned by the advertiser to generate a tag map request requirement or requirements. These preferences include, e.g., location, demonstration, topic, a blacklist, or other items. Advertisers have the option to filter their advertising campaigns to tags categorized by location (e.g., advertise tags available in the Mission district in San Francisco, topic (e.g., advertise tags related to techno music), demographics (e.g., advertise tags created by females aged 18-34 or viewed mostly by males aged 12-19) and blacklists (e.g., avoid advertising to any tags related to certain trademarks or problematic categories such as ethnicity).

Next in step 36, a tag maps manager, which is other computer logic also embodied in software, matches the advertiser's request against the indices set in step 30 and returns the base tag maps for the tag maps ad unit. These are the tag maps as described in Naaman. “Base” refers to the Naaman-type tag maps, not those in accordance with the present invention.

Next in step 38, the engine as further described below retrieves user information data to further refine the tag map content or blank, if necessary.

Next in step 40, the engine combines the advertising copy, also referred to as advertisements, and the tag maps and the related user generated content into a single tag map ad unit instance and returns this unit to the requesting user. Then in step 44, the tag map ad unit is displayed to the target user. In step 46, the user interacts with his tag map ad unit by clicking on portions thereof since it is an interactive web object. Finally in step 50, the user can mouse click or otherwise select on the tags in the ad unit, the user generated content or the advertisements themselves, all of which are interactive.

FIG. 4 shows a system for carrying out the FIG. 3 method. Some elements of this are wholly conventional. In general, the system of FIG. 4 is carried out in the context of conventional Internet communications, Internet servers, Internet host and clients and associated processors and storage media. The storage elements shown in the FIG. 4 are conventional computer storage media, referring to computer storage type such as disk drives, tape drives, or semiconductor computer memory or other media. The communication between the various elements of FIG. 4 is typically carried out by propagation of electrical signals as conventional in the computer field.

Starting at the top of FIG. 4, the advertising management server 60 is a server of conventional type which processes the advertisements. This is coupled to an advertisements (advertising copy) database 64, conventionally stored on a computer storage media. As shown, advertisers download their advertising copy (“ads”) to the advertising management server 60, which stores the advertising copy in associated advertisement database 64. These ads are digital content and in the form as described above. Typically advertising management server 60 is in communication, via the Internet 88 or other type of computer network, with a tag maps advertising engine 70. Engine 70 is server based, executing on a conventional computer processor and associated memory. Also provided is a tag maps database 72, which is also stored on a computer storage media storing conventional tag maps as described above.

Coupled to the tag maps advertising engine 70 is a user generated content (UGC) database 80 also stored on a computer storage media which stores user generated content as described above and which is coupled to a tag maps manager 78 which is a server based software module.

The elements shown in upper half of FIG. 4 are generally under control of the system operator (or operators) and constitute the system's host or “backend” portion. Elements shown in FIG. 4 below the second instance of the Internet 88 (to which the tag maps advertising engine 74 is coupled) are at the client (user) side and indicate user activity and the supporting user software and computing devices. The first of these is the user client generation of location related content 90. That is, using client software 90 (such as a conventional web browser or other content-browsing user interface such as a GPS device user interface) operated on his computer system or other computing device, a particular user generates location related content, also referred to here as user generated content. This content is location related as explained above. This UGC is then transmitted via the Internet 88 to the tag maps advertising engine 74 for storage in the UGC database 80. Also on the client side are the “targets” or other users who are receiving the advertising units. The first of these is indicated as having a mobile user client 92. This client 92 is typically software operated on a cell phone device, personal digital assistant, etc., and which is some sort of mobile computer software executing on its own computer platform or computer-like device 92. Typically this includes at a minimum a web browser in addition to the conventional user input and output elements, or a content-browsing user interface.

Included with client 92 is a user profile 96 and user data 98, which may be locally stored at the client, but also transmitted via the Internet back to the tag maps advertising engine 74, as needed. The user profile 96 and user data 98 are conventional in the field; each pertains to the particular user of the mobile user client 92. Another type of similar advertising target which is essentially the same, but using a different computing platform, is online user client 100. Typically this is software executed on a mobile computing device, personal computer or laptop computer. Again this has an associated user profile 102 and user data 104, but is otherwise the same as mobile user client 92.

The tag maps database 72 shown in FIG. 4 is part of the conventional tag maps technology shown in Naaman et al. and hence not shown here in further detail. The nature of the maps in maps database 72 is, for instance, the familiar Yahoo! maps combined with the tag maps function of Naaman or other types of computer oriented mapping functionality. These are typically interactive maps including zoom in and out and drag functions as familiar with Internet based mapping.

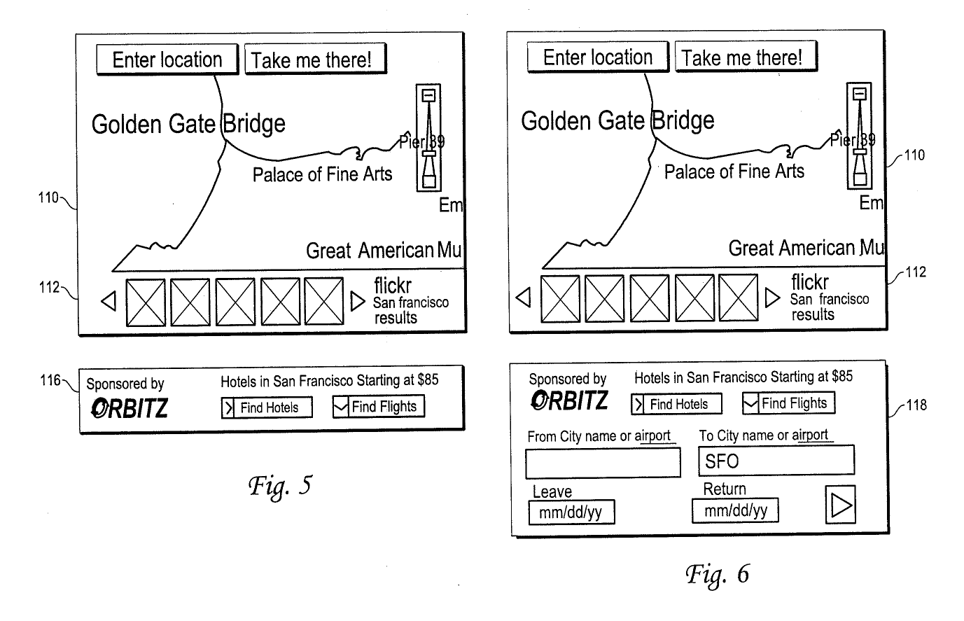

The results of the process of FIG. 3 using the system of FIG. 4 are expressed in “screenshots” of web pages as shown in FIGS. 5 and 6. FIG. 5 shows a typical tag map advertising unit as a web page for display on the user's computer, for instance mobile user client 92 or online user client 100. The upper portion 110 includes a tag map which is a map of a portion of the city of San Francisco including certain text tags. In the central portion of the figure is the set of user generated content 112. In this case, this is a set of photos supported by the Flickr™ website for various locations in San Francisco. Content 112 is user generated and uploaded by, for instance, the user client 90 shown in FIG. 4. In other words, these are a user's Flickr photos of San Francisco. In the bottom portion 116 of FIG. 5 is shown the advertising copy, in this case, advertising for Orbitz, the online travel site showing in this case “Hotels in San Francisco Starting at $85” with interactive buttons to find hotels or airline flights. In this case, Orbitz is the advertiser that is supplying the advertisements which are input into advertising management server 60 in this case by Orbitz or by its agent. Portion 116 is an interactive advertisement here, although this is not a requirement. Hence as shown in FIG. 5, there is the tag map portion 110, the user generated content 112, and the interactive advertising copy 116. These are all assembled by the tag maps advertising engine 70 of FIG. 4.

A variation on the FIG. 5 tag map advertising unit is shown in the screenshot of FIG. 6, which is largely identical to FIG. 5, except in this case the advertising copy 118 is expanded to include part of the actual Orbitz website for finding airline flights, indicating what happens when one clicks on the “Find Flights” button in 116 in FIG. 5. In other words, copy 118 is not only an advertisement, it is also a link to the Orbitz website and in that sense an interactive advertisement.

Of course the advertising copy need not be limited to travel, but may be any sort of commercial or non-commercial advertising and the advertising itself need not be geo-location based, although it is in the examples of FIGS. 5 and 6. Typically in the case of the interactive type advertisement, clicking on the advertisement or portion thereof links to a particular advertiser's website, for instance in this case Orbitz or may link to the Flickr website if one clicks on the middle portion 112 of FIG. 5. Once a user reaches that website, conventionally he has access to the entire functionality of that website as directed thereby the advertiser.

The format of the advertising content may be any sort of web oriented format such as Geo RSS XML format, XL, CSV, XML, API or others. Again this is not limiting.

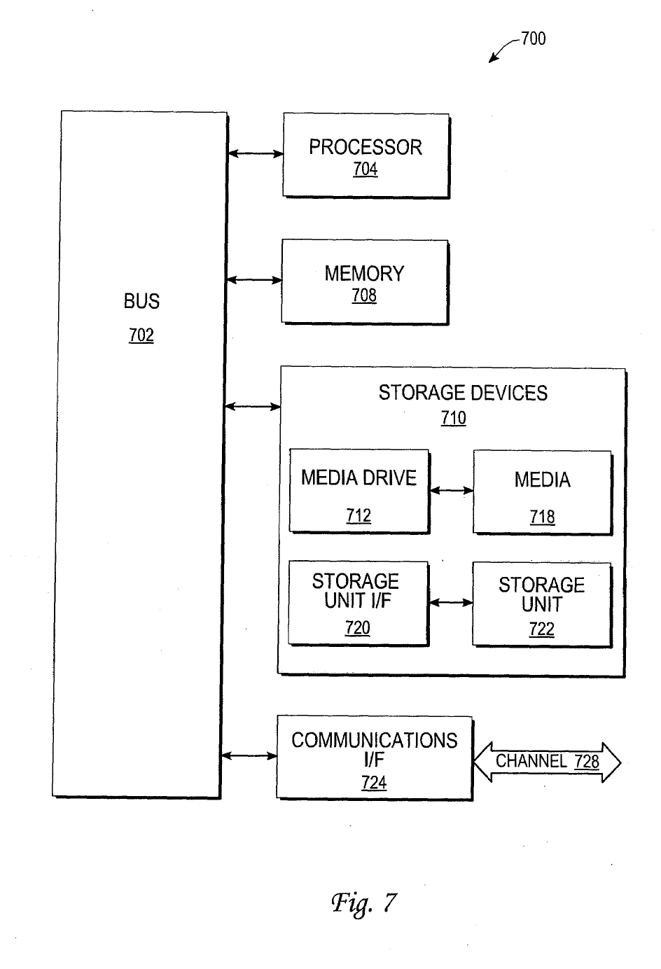

This description is illustrative and not limiting. The types of computers supporting the server or servers shown in FIG. 4 are conventional and an example is shown in FIG. 7. The represents a conventional computer or workstation or server. The same or portions of this functionality may also be present in the computing devices hosting the clients shown in FIG. 4.

As is conventional, the various software modules referred to here may be coded in any conventional language. The portions which involve web pages typically are coded in XML, HTML, etc. The remaining software portions may be coded for instance in C++ or any other conventional language. These computer programs include a set of instructions as is conventional intended to carry out the steps of the computer program and are typically stored in their own memory associated with a processor as shown in FIG. 7. The stored code may be in the form of source code and/or object (compiled) code.

FIG. 7 thereby illustrates a typical computing system 700 that may be employed to implement processing functionality in embodiments of the invention. Computing systems of this type may be used in the any one or more of the servers and user computers, for example. Those skilled in the relevant art will also recognize how to implement embodiments of the invention using other computer systems or architectures. Computing system 700 may represent, for example, a desktop, laptop or notebook computer, hand-held computing device (personal digital assistant (PDA), cell phone, palmtop, etc.), mainframe, server, client, or any other type of special or general purpose computing device as may be desirable or appropriate for a given application or environment. Computing system 700 can include one or more processors, such as a processor 704. Processor 704 can be implemented using a general or special purpose processing engine such as, for example, a microprocessor, microcontroller or other control logic. In this example, processor 704 is connected to a bus 702 or other communications medium.

Computing system (apparatus) 700 can also include a main memory 708, such as random access memory (RAM) or other dynamic memory, for storing information and instructions to be executed by processor 704. Main memory 708 also may be used for storing temporary variables or other intermediate information during execution of instructions to be executed by processor 704. Computing system 700 may likewise include a read only memory (ROM) or other static storage device coupled to bus 702 for storing static information and instructions for processor 704.

The computing system 700 may also include information storage system 710, which may include, for example, a media drive 712 and a removable storage interface 720. The media drive 712 may include a drive or other mechanism to support fixed or removable storage media, such as a hard disk drive, a floppy disk drive, a magnetic tape drive, an optical disk drive, a compact disk (CD) or digital versatile disk (DVD) drive (R or RW), or other removable or fixed media drive. Storage media 718 may include, for example, a hard disk, floppy disk, magnetic tape, optical disk, CD or DVD, or other fixed or removable medium that is read by and written to by media drive 714. As these examples illustrate, the storage media 718 may include a computer-readable storage medium having stored therein particular computer software or data.

In alternative embodiments, information storage system 710 may include other similar components for allowing computer programs or other instructions or data to be loaded into computing system 700. Such components may include, for example, a removable storage unit 722 and an interface 720, such as a program cartridge and cartridge interface, a removable memory (for example, a flash memory or other removable memory module) and memory slot, and other removable storage units 722 and interfaces 720 that allow software and data to be transferred from the removable storage unit 718 to computing system 700.

Computing system 700 can also include a communications interface 724. Communications interface 724 can be used to allow software and data to be transferred between computing system 700 and external devices. Examples of communications interface 724 can include a modem, a network interface (such as an Ethernet or other network interface card (NIC)), a communications port (such as for example, a USB port), a PCMCIA slot and card, etc. Software and data transferred via communications interface 724 are in the form of signals which can be electronic, electromagnetic, optical or other signals capable of being received by communications interface 724. These signals are provided to communications interface 724 via a channel 728. This channel 728 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product,” “computer-readable medium” and the like may be used generally to refer to media such as, for example, memory 708, storage device 718, or storage unit 722. These and other forms of computer-readable media may store one or more instructions for use by processor 704, to cause the processor to perform specified operations. Such instructions, generally referred to as “computer program code” (which may be grouped in the form of computer programs or other groupings), when executed, enable the computing system 700 to perform functions of embodiments of the invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 700 using, for example, removable storage drive 714, drive 712 or communications interface 724. The control logic (in this example, software instructions or computer program code), when executed by the processor 704, causes the processor 704 to perform the functions of embodiments of the invention as described herein.

The above description is intended to be illustrative and not limiting. Further improvements and modifications will be apparent to those skilled in the art and are intended to fall within the scope of the appended claims.

1. A method performed by a computing apparatus of providing information associated with a map displayed by a computing apparatus, comprising the acts of:
a processor providing a plurality of objects from an associated memory, each object being associated with a location on the displayed map;
the processor accepting user selection of a particular map location; and
the processor retrieving from the memory and displaying on the map at least one of the objects associated with the particular map location; wherein the objects are interactive.

2. The method of claim 1, wherein the objects include a link to a document or a website.

3. The method of claim 1, wherein the objects each include a graphical image or video or audio.

4. The method of claim 1, wherein the displaying includes displaying a plurality of objects for the particular location.

5. The method of claim 1, wherein the objects include user generated content and advertising content.

6. The method of claim 1, wherein the objects include advertising content.

7. The method of claim 1, wherein the map is provided from a first server and the objects are provided from a second server remote from the first server.

8. The method of claim 1, wherein the objects are map tags.

9. The method of claim 1, further comprising the act of providing a temporal parameter associated with at least one of the objects.

10. The method of claim 1, wherein the interactivity includes at least one of zooming, traversing, shifting, change in size, moving, combining with an advertisement, and linking to a website.

11. The method of claim 1, wherein the objects are associated with map locations by keywords.

12. A computer readable medium storing computer code for carrying out the method of claim 1.

13. The method of claim 1, wherein the method is performed by a computing apparatus programmed to be a special purpose machine pursuant to instructions from program software.

14. Apparatus for providing information associated with a displayed map, comprising:
a first server storing a plurality of maps and having a port connectable to a network; and
a second server storing a plurality of objects, each associated with a location on the displayed map and wherein the second server is coupled to the first server, and wherein the objects are interactive;
wherein the first and second servers, responsive to a user selection of a particular map location, provide over the network the displayed map with at least one of the objects associated with the particular map location.

15. The apparatus of claim 14, wherein the objects include a link to a document or a website.

16. The apparatus of claim 14, wherein the objects each include a graphical image or video or audio.

17. The apparatus of claim 14, wherein the displayed map includes a plurality of objects for the particular location.

18. The apparatus of claim 14, wherein the objects include user generated content and advertising content.

19. The apparatus of claim 14, wherein the objects include advertising content.

20. The apparatus of claim 14, wherein the second server is remote from the first server.

21. The apparatus of claim 14, wherein the objects are map tags.

22. The apparatus of claim 14, wherein a temporal parameter is associated with at least one of the objects.

23. The apparatus of claim 14, wherein the interactivity of the objects includes at least one of zooming, traversing, shifting, change in size, moving, combining with an advertisement, and linking to a website.

24. The apparatus of claim 14, wherein the objects are associated with map locations by keywords.
